(19) United States
(12) Patent Application Publication
(10) Pub. No.: US 2026/0246114 A1
(43) Pub. Date: Aug. 20, 2026

(54) BATTERY TERMINAL UNIT

(71) Applicant: SUMITOMO WIRING SYSTEMS, LTD., Mie (JP)

(72) Inventors: Masaya INOUE, Mie (JP); Yuki SUGIMOTO, Mie (JP); Takuya OSHITA, Mie (JP)

(21) Appl. No.: 19/536,973

(22) Filed: Feb. 11, 2026

(30) Foreign Application Priority Data
Feb. 17, 2025 (JP) 2025-022987

(51) Int. Cl. H01M 50/553; H01M 50/176; H01M 50/209; H01M 50/516; H01M 50/517; H01R 11/28

(52) U.S. Cl. CPC H01M 50/553; H01M 50/176; H01M 50/209; H01M 50/516; H01M 50/517; H01R 11/283; H01R 11/284

(57) ABSTRACT

A battery terminal unit includes a battery terminal configured to be connected to a battery post of a battery, and a base member configured to be mounted to the battery terminal. The base member includes a base rotation suppressing part capable of coming into contact with a base abutting surface of a casing of the battery in a direction in which the battery terminal rotates relative to the battery, and a coupling part for attaching an attachment member configured to come into contact with the casing.

### CROSS-REFERENCE TO RELATED APPLICATIONS

This application is based on and claims priority from Japanese Patent Application No. 2025-022987, filed on Feb. 17, 2025, with the Japan Patent Office, the disclosure of which is incorporated herein in its entirety by reference.

### TECHNICAL FIELD

The present disclosure relates to a battery terminal unit.

### BACKGROUND

The battery terminal unit disclosed in JP 2015-118855 A includes a battery terminal connected to a battery post, and a battery terminal stopper that suppresses the battery terminal from rotating relative to a battery about the battery post. The battery terminal stopper is mounted to the battery terminal. Also, the battery terminal stopper includes a first rotation preventing part and a second rotation preventing part that abut against side surfaces of a battery casing in the rotation direction of the battery terminal.

### SUMMARY

In the case of JP 2015-118855 A, there is an issue of lack of versatility because the mode of attachment of the battery terminal to the battery is fixed and cannot accommodate possible changes in the state of attachment.

Therefore, it is an object of the present disclosure to increase the versatility of a battery terminal unit.

A battery terminal unit according to the present disclosure is a battery terminal unit including: a battery terminal configured to be connected to a battery post of a battery; and a base member configured to be mounted to the battery terminal, wherein the base member includes a base rotation suppressing part capable of coming into contact with a base abutting surface of a casing of the battery in a direction in which the battery terminal rotates relative to the battery about an axis of the battery post, and a coupling part for attaching an attachment member configured to come into contact with the casing.

According to the present disclosure, it is possible to provide a battery terminal unit for which versatility can be increased.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a first attachment mode of a battery terminal unit according to Embodiment 1, as viewed from above.

FIG. 2 is a cross-sectional view of the battery terminal unit according to Embodiment 1 in a state in which a battery terminal is connected to a battery post, and an interposed member is locked to the battery terminal.

FIG. 3 is a perspective view of the battery terminal unit according to Embodiment 1, as viewed from above.

FIG. 4 is a perspective view of the battery terminal of the battery terminal unit according to Embodiment 1, as viewed from above.

FIG. 5 is a perspective view of a base member of the battery terminal unit according to Embodiment 1, as viewed from above.

FIG. 6 is a perspective view of the base member of the battery terminal unit according to Embodiment 1, as viewed from below.

FIG. 7 is a perspective view of the interposed member of the battery terminal unit according to Embodiment 1, as viewed from above.

FIG. 8 is a perspective view of the interposed member of the battery terminal unit according to Embodiment 1, as viewed from below.

FIG. 9 is a perspective view of a second attachment mode of the battery terminal unit according to Embodiment 1, as viewed from above.

FIG. 10 is a cross-sectional view of the battery terminal unit according to Embodiment 1 in a state in which the base member is mounted to the battery terminal, and an attachment member is attached to the base member.

FIG. 11 is a perspective view of the attachment member shown in FIGS. 9 and 10 of the battery terminal unit according to Embodiment 1, as viewed from above.

FIG. 12 is a perspective view of a third attachment mode of the battery terminal unit according to Embodiment 1, as viewed from above.

FIG. 13 is a perspective view of an attachment member shown in FIG. 12 of the battery terminal unit according to Embodiment 1, as viewed from above.

FIG. 14 is a perspective view of a fourth attachment mode of the battery terminal unit according to Embodiment 1, as viewed from above.

FIG. 15 is a perspective view of an attachment member shown in FIG. 14 of the battery terminal unit according to Embodiment 1, as viewed from above.

FIG. 16 is a perspective view of a fifth attachment mode of the battery terminal unit according to Embodiment 1, as viewed from above.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, embodiments of the present disclosure will be listed and described.

(1) A battery terminal unit of the present disclosure includes: a battery terminal configured to be connected to a battery post of a battery; and a base member configured to be mounted to the battery terminal, wherein the base member includes a base rotation suppressing part capable of coming into contact with a base abutting surface of a casing of the battery in a direction in which the battery terminal rotates relative to the battery about an axis of the battery post, and a coupling part for attaching an attachment member configured to come into contact with the casing.

As a result of the base rotation suppressing part of the battery terminal coming into contact with the base abutting surface of the casing of the battery, the battery terminal is suppressed from rotating relative to the battery. In the case of changing the mode of attachment of the battery terminal to the battery, the attachment member can be attached to the base member via the coupling part. This makes it possible to support various attachment modes, thus increasing the versatility of attachment of the battery terminal unit.

(2) In the battery terminal unit according to (1) above, it is preferable that the battery terminal unit further includes the attachment member, wherein the attachment member includes an attachment rotation suppressing part capable of coming into contact with an attachment abutting surface of the casing in the direction in which the battery terminal rotates relative to the battery.

As a result of both the base rotation suppressing part and the attachment rotation suppressing part coming into contact with the casing, it is possible to increase the reliability in suppressing the battery terminal from rotating relative to the battery.

(3) In the battery terminal unit according to (2) above, it is preferable that, in a state in which the attachment member is attached to the base member, respective abutted surfaces of the attachment rotation suppressing part and the base rotation suppressing part are oriented in directions different from each other.

The respective abutted surfaces and of the attachment rotation suppressing part and the base rotation suppressing part can come into contact with the attachment abutting surface and the base abutting surface, respectively, from directions different from each other, thus making it possible to prevent the battery terminal from being positionally displaced relative to the battery when a force in the rotation direction acts on the battery terminal.

(4) In the battery terminal unit according to (2) or (3) above, it is preferable that the coupling part includes a locking hole that is open downward, and the attachment member includes a locking part configured to be inserted into and locked to the locking hole from below, with a distal end thereof oriented upward.

The attachment member is attached to the base member from below. Accordingly, the attachment member is sandwiched and stably held between the base member and the battery.

(5) In the battery terminal unit according to any one of (1) to (4) above, it is preferable that a plurality of the coupling parts are provided at different locations of the base member.

Various attachment members can be attached to the base member via at least one of the plurality of the coupling parts, thus making it possible to further widen the variations of the attachment modes.

### Details of Embodiments of the Present Disclosure

Specific examples of the present disclosure will be described below with reference to the drawings. It should be noted that the present invention is not limited to these examples, and is intended to include all modifications which fall within the scope of the claims and the meaning and scope of equivalents thereof.

### (Embodiment 1)

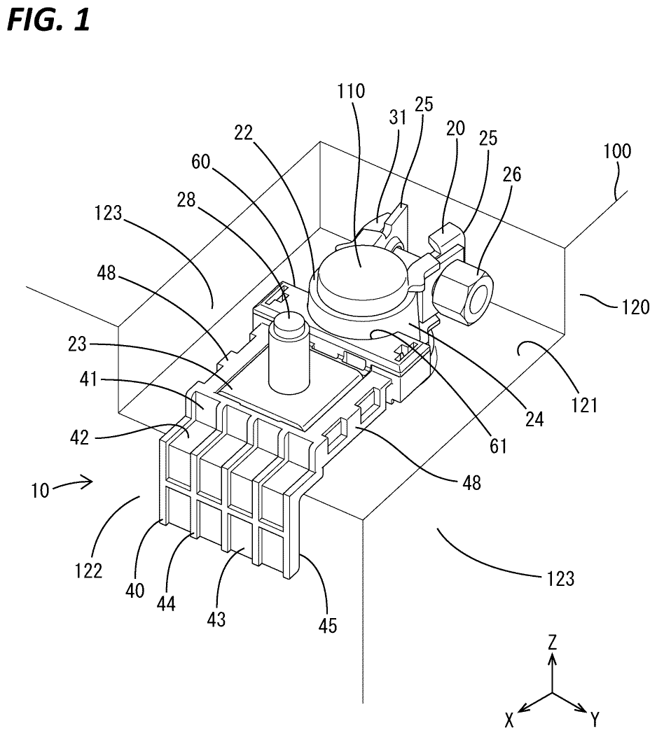

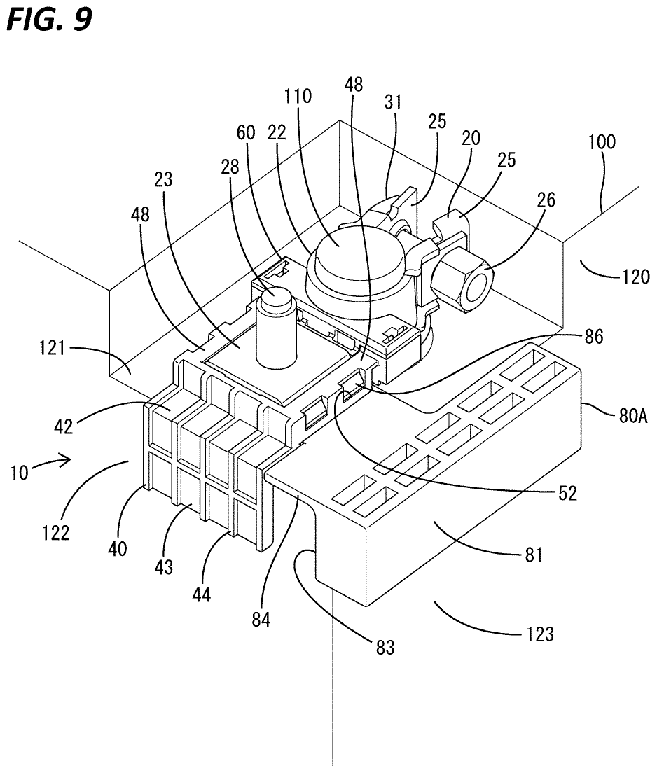

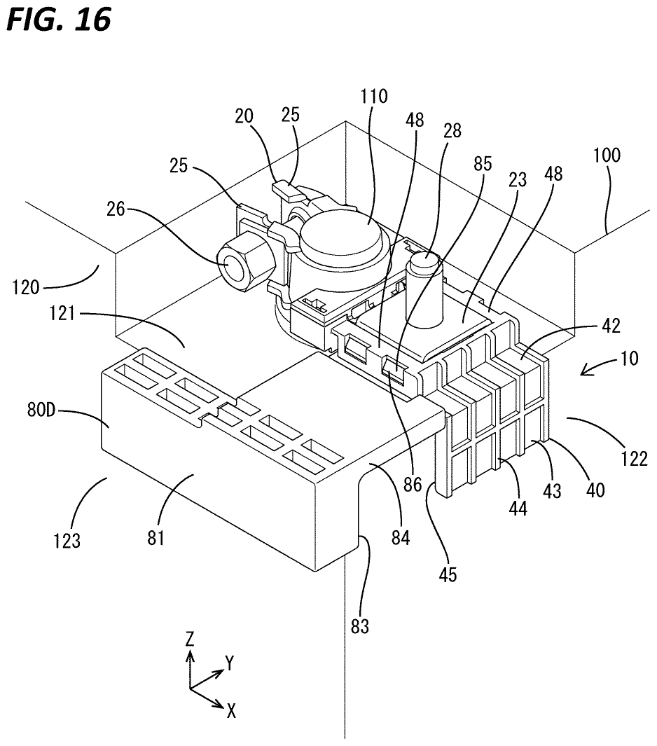

As shown in FIG. 1, a battery terminal unit 10 according to Embodiment 1 includes a battery terminal 20 configured to be connected to a battery post 110 of a battery 100, a base member 40 that is mounted to the battery terminal 20 and comes into contact with the battery 100, and an interposed member 60 disposed between the battery terminal 20 and the base member 40. In the case of Embodiment 1, as shown in FIGS. 9, 12, 14, and 16, the battery terminal unit 10 may include first to fourth attachment members 80A to 80D as options. In Embodiment 1, a plurality of types of the first to fourth attachment members 80A to 80D are provided so as to be selectable according to the need. In the following description, as for a front-rear direction, reference characters X, Y, and Z shown in FIGS. 1 and 16 indicate a forward direction, a rightward direction, and an upward direction, respectively. The reference directions are provided for the sake of convenience.

The battery 100 includes a box-shaped casing 120. The casing 120 includes an upper surface, a front surface, and a pair of left and right side surfaces. As shown in FIG. 1, the casing 120 includes, at one corner located on the right side and the front side among four corners thereof viewed from above, a recess 121 having a shape that is cut out over the front surface, the right side surface, and the upper surface. The bottom surface of the recess 121 constitutes a part of the upper surface of the casing 120. The battery 100 includes a battery post 110 protruding from the bottom surface of the recess 121. The battery post 110 has a shape that is columnar and has an upwardly decreasing diameter.

The front surface of the casing 120 is a vertical surface extending along the left-right direction and the up-down direction, and is configured as a base abutting surface 122 capable of coming into face-to-face contact with an abutted surface 45 of a base rotation suppressing part 43, which will be described later. Each of the right side surface of the casing 120, and a left side surface that is oriented rightward, among inner surfaces of the recess 121 of the casing 120, is a vertical surface extending along the front-rear direction and the up-down direction, and is configured as an attachment abutting surface 123 capable of coming into face-to-face contact with an abutted surface 83 of an attachment rotation suppressing part 81, which will be described later. Both the base abutting surface 122 and the attachment abutting surface 123 are connected at a right angle to the bottom surface of the recess 121.

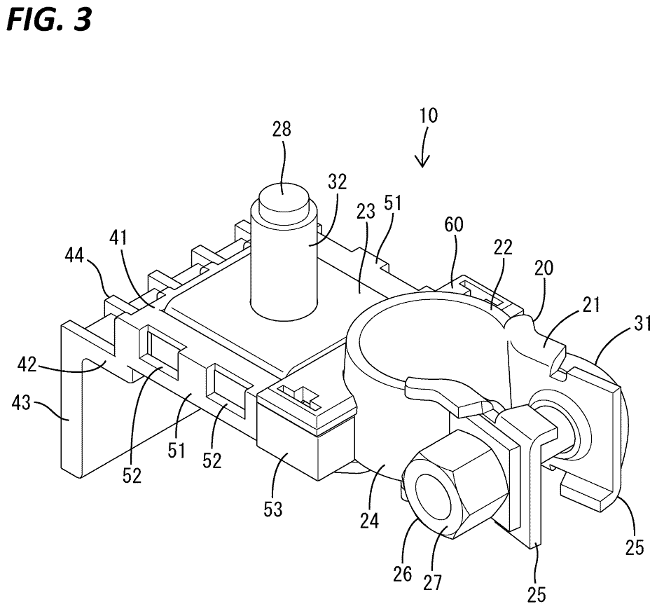

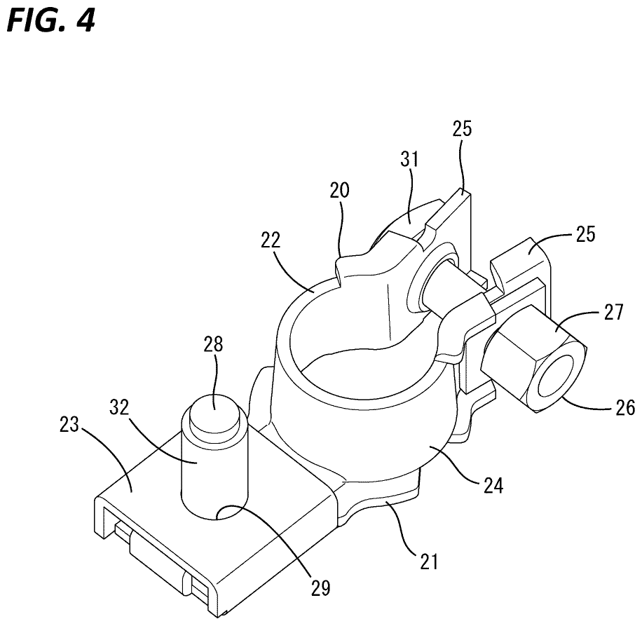

As shown in FIGS. 3 and 4, the battery terminal 20 includes a terminal body 21 made of a conductive metal plate material. The terminal body 21 is formed by punching out the metal plate material, followed by bending or the like. The terminal body 21 includes a post coupling part 22 and a stud bolt holding part 23. The post coupling part 22 includes a surrounding portion 24 having an arc shape in plan view. As shown in FIG. 1, the surrounding portion 24 is attached to the battery post 110 so as to surround the outer circumference of the battery post 110. As shown in FIG. 4, the post coupling part 22 includes a pair of fastening parts 25 protruding rearward from circumferentially opposite ends constituting a rear end of the surrounding portion 24. The fastening parts 25 oppose each other so as to be spaced apart in the left-right direction. A bolt 26 is inserted through the fastening parts 25. A head portion 27 of the bolt 26 is disposed on one of the fastening parts 25, and a nut 31 is disposed on the other fastening part 25. As a result of a shaft of the bolt 26 being fastened to the nut 31, the fastening parts 25 approach each other in the left-right direction, whereby the diameter of the surrounding portion 24 is reduced. As a result of the diameter of the surrounding portion 24 being reduced, the post coupling part 22 is held against the battery post 110 and connected thereto (see FIG. 1).

As shown in FIG. 4, the stud bolt holding part 23 is disposed forward of the surrounding portion 24. The stud bolt holding part 23 has a rectangular tubular shape that is quadrangular in plan view and is flat in the up-down direction, and the inside thereof is open in the front-rear direction. A head portion (not shown) of a stud bolt 28 is accommodated inside the stud bolt holding part 23. The head portion of the stud bolt 28 is held inside the stud bolt holding part 23. A bolt through hole 29 is provided in the upper wall of the stud bolt holding part 23. A shaft portion 32 of the stud bolt 28 stands upward from the bolt through hole 29. A metal fitting or the like connected to an end portion of a wire (not shown) is connected to the shaft portion 32 of the stud bolt 28.

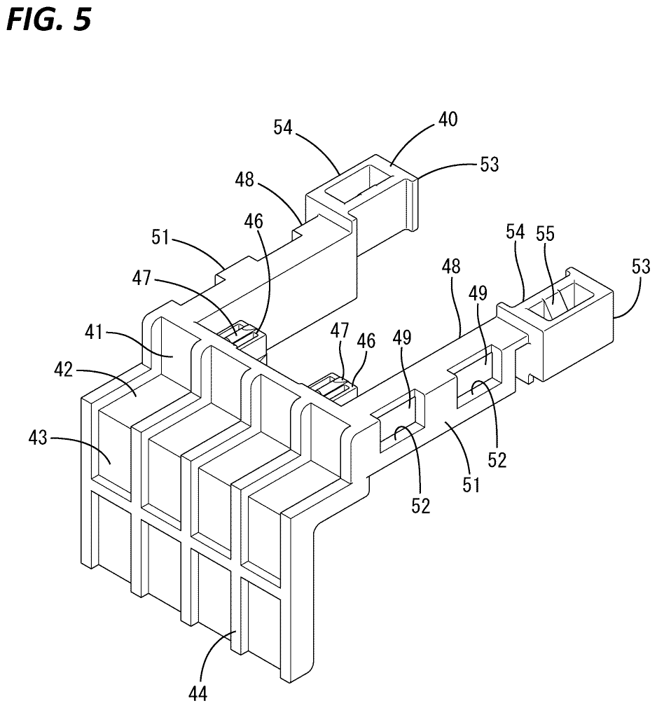

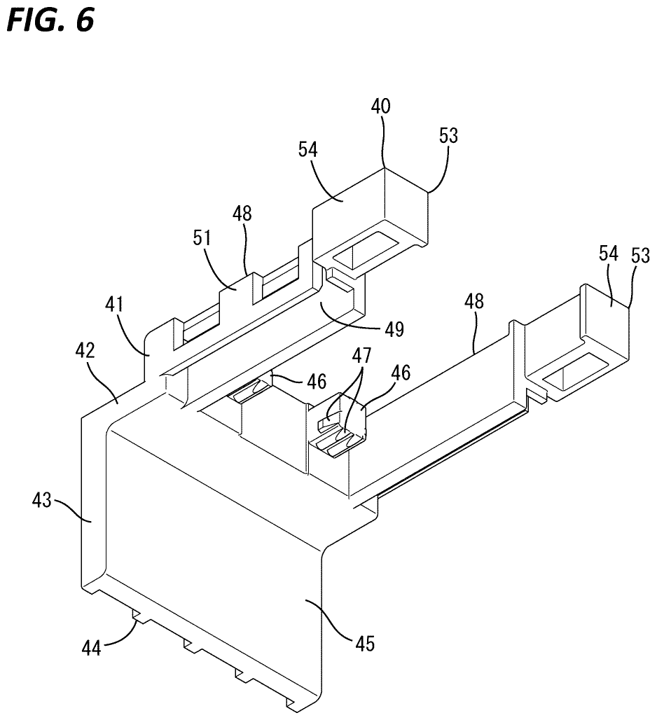

The base member 40 is made of synthetic resin, and includes a base basal part 41, a base installation part 42, and a base rotation suppressing part 43, as shown in FIGS. 5 and 6. All of the base basal part 41, the base installation part 42, and the base rotation suppressing part 43 have a plate shape that is wide in the left-right direction, and each extend continuously in the same width in the left-right direction. The base installation part 42 extends in a short length in the front-rear direction. The base basal part 41 protrudes upward from the rear end of the base installation part 42. The base installation part 42 and the base basal part 41 form an L-shape in side view.

The base rotation suppressing part 43 protrudes downward from the front end of the base installation part 42. The base installation part 42 and the base rotation suppressing part 43 form an L-shape in side view. The amount of downward protrusion of the base rotation suppressing part 43 is greater than the amount of upward protrusion of the base basal part 41. The upper surface of the base installation part 42, the front surface of the base basal part 41, and the front surface of the base rotation suppressing part 43 constitute the front side of the base member 40. On this side of the base member 40, a grid-patterned rib 44 is provided for the purpose of reinforcement, strength enhancement, and the like.

The lower surface of the base installation part 42, the rear surface of the base basal part 41, and the rear surface of the base rotation suppressing part 43 constitute the back side of the base member 40. As shown in FIG. 6, the lower surface of the base installation part 42 is a flat surface extending along the front-rear direction and the left-right direction. Both the rear surface of the base basal part 41 and the rear surface of the base rotation suppressing part 43 are vertical surfaces extending along the up-down direction and the left-right direction. The lower surface of the base installation part 42 is disposed so as to face the bottom surface of the recess 121 of the casing 120 from above (see FIG. 1). The rear surface of the base rotation suppressing part 43 is configured as an abutted surface 45 that faces the base abutting surface 122 of the casing 120 from the front.

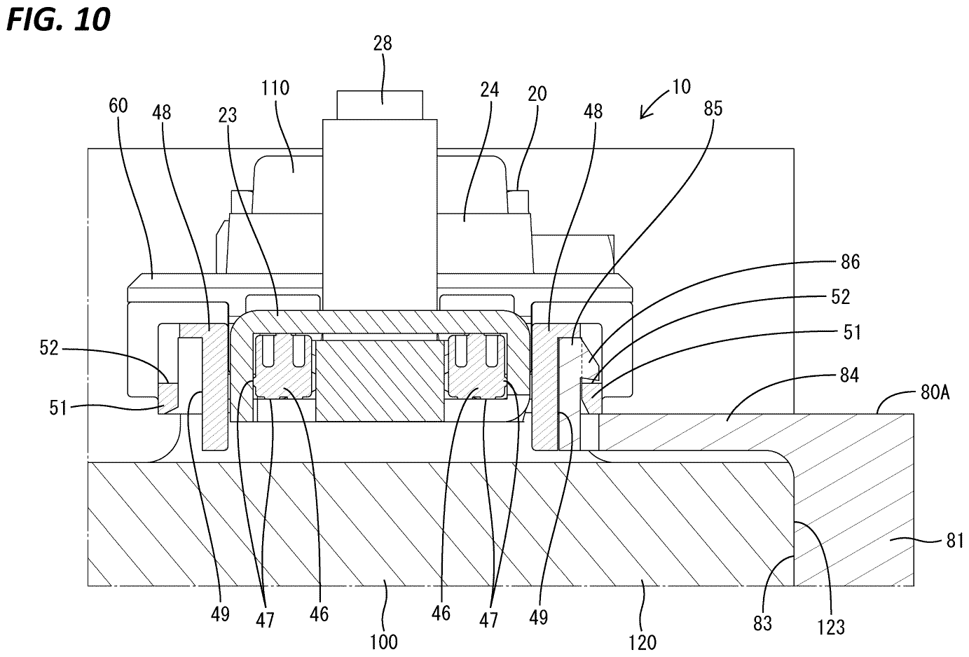

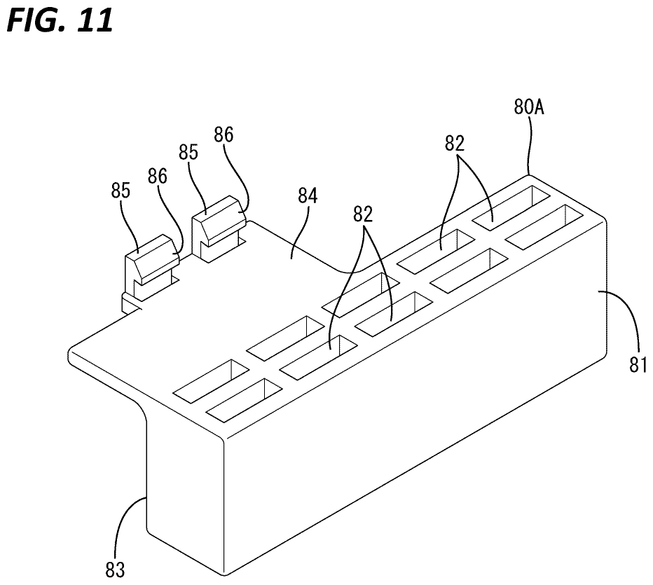

As shown in FIG. 1, the base basal part 41 is disposed so as to oppose the stud bolt holding part 23 of the battery terminal 20 from the front. The base basal part 41 closes the front end opening surface of the stud bolt holding part 23. As shown in FIGS. 5 and 6, the base member 40 includes a pair of left and right mounting parts 46 protruding rearward from positions near laterally opposite ends on the rear surface of the base basal part 41. The mounting parts 46 have a rectangular block shape. A plurality of ridge parts 47 are provided on the outer surface of each of the mounting parts 46 so as to extend in the front-rear direction. As shown in FIG. 10, the mounting parts 46 are inserted inside the stud bolt holding part 23 from the front. The ridge parts 47 may be squeezed by coming into contact with the inner surface of the stud bolt holding part 23. As a result of the mounting parts 46 being press-fitted into the stud bolt holding part 23 in this manner, the base member 40 is held by the terminal body 21 of the battery terminal 20.

As shown in FIGS. 5 and 6, the base member 40 includes a pair of left and right coupling parts 48 extending rearward from laterally opposite ends of the base basal part 41. Each of the coupling parts 48 extends in the front-rear direction, and have a gate-shaped cross section that is elongated in the up-down direction relative to the left-right direction. A laterally inner surface of each of the coupling parts 48 and a laterally outer surface of the corresponding mounting part 46 face each other in the left-right direction. As shown in FIG. 1, the coupling parts 48 are disposed along the outer surfaces of left and right side walls, respectively, of the stud bolt holding part 23 of the battery terminal 20. As shown in FIG. 10, the left and right side walls of the stud bolt holding part 23 are sandwiched between the coupling parts 48 and the respective corresponding mounting parts 46.

Each of the coupling parts 48 includes locking holes 49 that extend in the up-down direction and are open on the lower surface of the coupling part 48. Each of the coupling parts 48 includes an inner wall portion and an outer wall portion 51 that oppose each other in the left-right direction with the locking holes 49 interposed therebetween. The outer wall portion 51 that covers the locking holes 49 from a laterally outer side is elastically deformable in the left-right direction with upper end portions of the coupling parts 48 serving as support points. As shown in FIG. 5, the locking holes 49 are open in a quadrangular shape in side view on a laterally outer surface of the outer wall portion 51 at two locations spaced apart in the front-rear direction. Here, the locking holes 49 are open from an upper portion of the outer wall portion 51 to an upper end face of the coupling part 48. As shown in FIG. 10, an opening lower edge of each locking hole 49 on the outer wall portion 51 is configured as a locking edge 52 capable of locking to a locking projection 86 of each of the first to fourth attachment members 80A to 80D, which will be described later. The locking edge 52 is disposed so as to extend along the left-right direction and oriented upward.

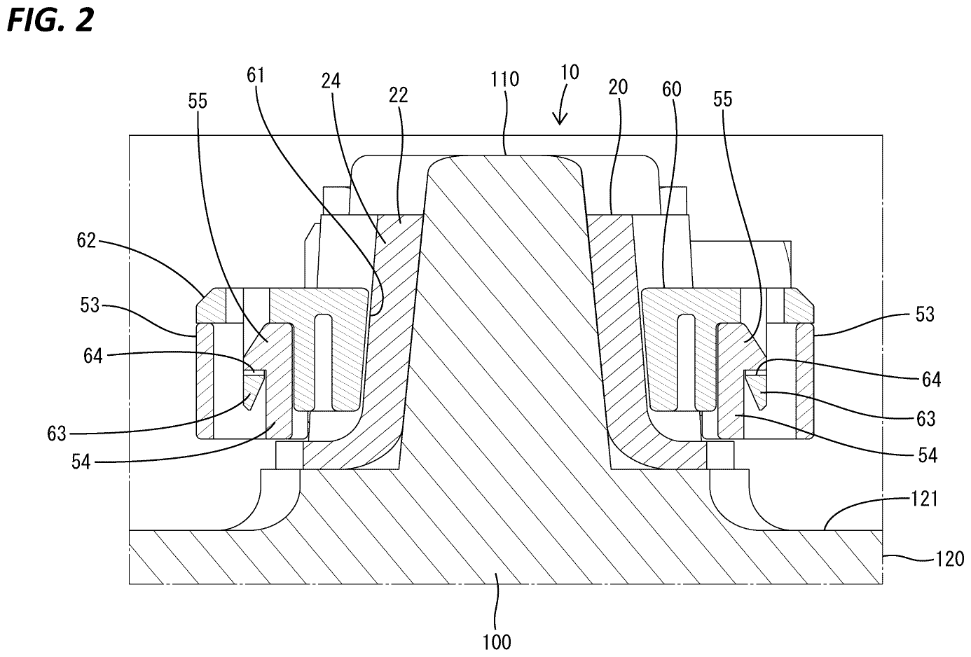

As shown in FIGS. 5 and 6, the base member 40 includes a pair of left and right base end portions 53 protruding rearward from the rear ends of the coupling parts 48. Each of the base end portions 53 includes a frame part 54 that has a rectangular tubular shape and is open in the up-down direction, and a pawl part 55 (only one pawl part 55 is illustrated in FIG. 5; see FIG. 2) protruding to the inside of the frame part 54 from a laterally inner surface (surface oriented laterally outward) of the frame part 54.

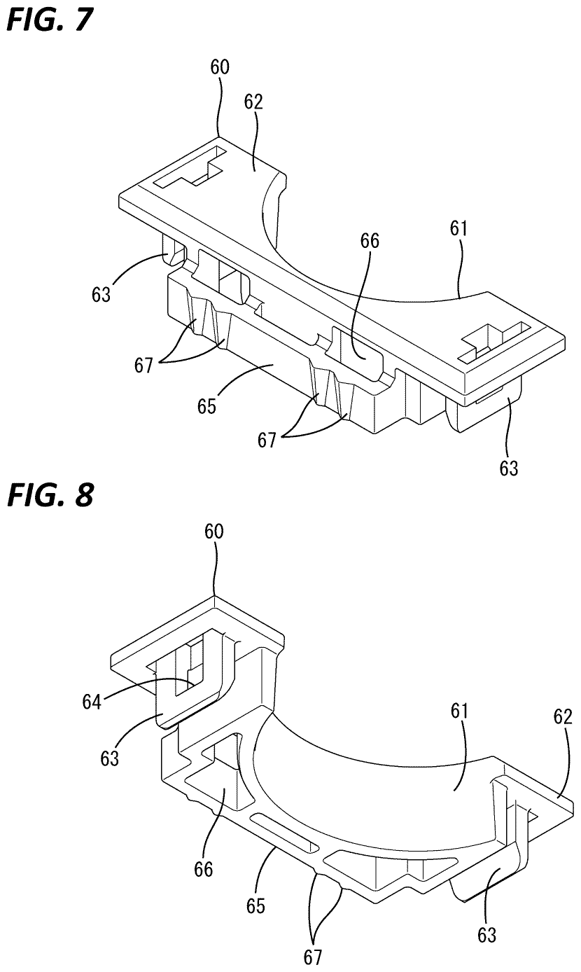

The interposed member 60 is made of synthetic resin, and has an overall shape extending in the left-right direction. As shown in FIG. 1, the interposed member 60 is sandwiched in the front-rear direction between the post coupling part 22 and the stud bolt holding part 23 of the battery terminal 20. As shown in FIGS. 7 and 8, an engaging recess 61 having an arc shape in plan view is provided on the rear surface of the interposed member 60. As shown in FIG. 1, the engaging recess 61 is disposed along a front surface portion of the outer circumference of the surrounding portion 24 of the post coupling part 22. As shown in FIGS. 7 and 8, an upper end portion of the interposed member 60 is constituted by a plate-shaped flat plate part 62. The engaging recess 61 is open at the rear end of a laterally central portion of the flat plate part 62. The interposed member 60 includes a pair of left and right elastic lock parts 63 protruding downward from positions near laterally opposite ends of the flat plate part 62. Each of the elastic lock parts 63 has a plate shape, and is elastically deformable in the left-right direction with a portion thereof coupled to the flat plate part 62 serving as a support point. As shown in FIG. 2, each of the elastic lock parts 63 includes a lock hole 64 extending therethrough in the left-right direction. The elastic lock parts 63 are inserted to the frame parts 54 of the respective corresponding base end portions 53 from below. The pawl parts 55 fit into the lock holes 64 of the respective corresponding elastic lock parts 63 and are locked thereto. As a result of the elastic lock parts 63 being locked to the respective corresponding base end portions 53, the interposed member 60 and the base member 40 are coupled and held to each other.

As shown in FIGS. 7 and 8, a press-contact part 65 is provided on the front surface of the interposed member 60. A thinned part 66 is provided between the press-contact part 65 and the flat plate part 62 of the interposed member 60 so as to partially pass through the interposed member 60. A plurality of press-contact ribs 67 are provided on the front surface of the press-contact part 65 so as to extend in the up-down direction. The press-contact parts 65 are disposed so as to cover a rear end opening surface of the stud bolt holding part 23 from the rear. The press-contact ribs 67 may be squeezed by coming into contact with the rear end of the upper wall of the stud bolt holding part 23. In a state in which the interposed member 60 is held by the base member 40, the engaging recess 61 come into contact with the post coupling part 22, and the press-contact parts 65 come into contact in a pressed state with the stud bolt holding part 23. As shown in FIG. 1, the space between the base member 40 and the post coupling part 22 is filled with the interposed member 60.

Next, a first attachment mode as a usage example of the battery terminal unit 10 will be described. As shown in FIG. 1, in the first attachment mode, the battery terminal unit 10 is composed of the battery terminal 20, the base member 40, and the interposed member 60, and does not include any attachment member.

The base member 40 is attached to the battery terminal 20 from the front. As a result of the mounting parts 46 being press-fitted inside the post coupling part 22, separation of the base member 40 from the battery terminal 20 is suppressed (see FIG. 10). Then, the interposed member 60 is attached to the base member 40 from above. The interposed member 60 is held by the base member 40 through locking between the pawl parts 55 of the base end portions 53 and the respective corresponding elastic lock parts 63, and the base member 40 and the interposed member 60 are held together by the battery terminal 20 (see FIGS. 2 and 3). Thus, a mode of the battery terminal unit 10 is configured.

Before or after the base member 40 and the interposed member 60 are held by the battery terminal 20, the battery terminal 20 of the battery terminal unit 10 is placed on the bottom surface of the recess 121 of the casing 120 of the battery 100. The surrounding portion 24 of the post coupling part 22 is disposed along the outer circumference of the battery post 110. The head portion 27 of the bolt 26 is disposed toward the right, which is the opening direction of the recess 121, relative to the fastening parts 25 (see FIG. 1).

In the above-described state, the bolt 26 is rotated to be fastened while the nut 31 is pressed, and the post coupling part 22 is connected and fixed to the battery post 110. Through fastening, a force in a rotation direction to rotate in the horizontal direction about the battery post 110 acts on the battery terminal 20. Here, the base rotation suppressing part 43 of the base member 40 is disposed face-to-face with the base abutting surface 122 of the casing 120 from the front, which is the rotation direction. Accordingly, when the battery terminal 20 is to rotate relative to the battery 100, the abutted surface 45 of the base rotation suppressing part 43 can come into contact with the base abutting surface 122. As a result, the battery terminal 20 is held so as to be prevented from rotating relative to the battery 100.

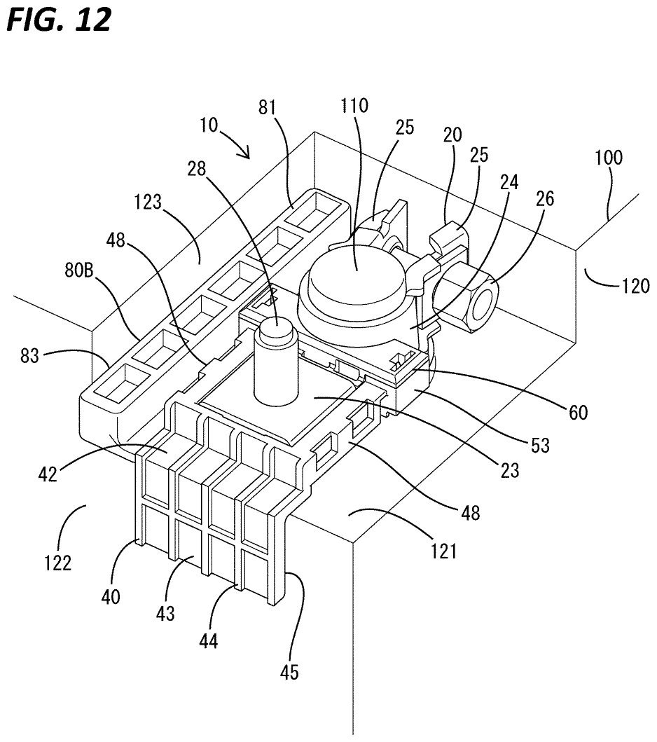

Next, a second attachment mode will be described. As shown in FIG. 9, the second attachment mode is constituted by a battery terminal unit 10 including the battery terminal 20, the base member 40, the interposed member 60, and the first attachment member 80A. As shown in FIG. 11, the first attachment member 80A in the second attachment mode includes a wall-shaped attachment rotation suppressing part 81 extending in the front-rear direction. The attachment rotation suppressing part 81 has a rectangular cross-sectional outer shape that is elongated in the up-down direction relative to the left-right direction. The attachment rotation suppressing part 81 includes a plurality of through holes 82. The through holes 82 extend in the up-down direction, and are open on the upper surface and the lower surface of the attachment rotation suppressing part 81. A plurality of the through holes 82 are arranged side by side in the front-rear direction and the left-right direction. The left surface of the attachment rotation suppressing part 81 is configured as an abutted surface 83 that contactably faces the attachment abutting surface 123 of the casing 120 of the battery 100. The abutted surface 83 of the attachment rotation suppressing part 81 is a vertical surface extending along the front-rear direction and the up-down direction.

The first attachment member 80A includes a projecting piece part 84 projecting leftward from the left surface of the attachment rotation suppressing part 81. The projecting piece part 84 has a quadrangular plate shape in plan view, and is coupled to a front portion and an upper end portion of the left surface of the attachment rotation suppressing part 81. The upper surface of the projecting piece part 84 is continuous with the upper surface of the attachment rotation suppressing part 81 without any difference in height. The front end face of the projecting piece part 84 is continuous with the front surface of the attachment rotation suppressing part 81 without any difference in height. In addition, the first attachment member 80A includes a plurality of (here, two) locking parts 85 protruding upward from the projecting piece part 84. The locking parts 85 have a plate shape, and are coupled in pairs to a left end of the projecting piece part 84 so as to be spaced apart in the front-rear direction. A pawl-shaped locking projection 86 protrudes rightward from the upper end of each of the locking parts 85.

The first attachment member 80A is attached to the base member 40 from below. The locking parts 85 are inserted into the locking holes 49 of the right coupling part 48 from below. In the process of inserting the locking parts 85, the outer wall portion 51 of the coupling part 48 comes into contact with the locking projections 86 and is elastically deformed rightward. Upon completion of insertion of the locking parts 85, the outer wall portions 51 of the coupling parts 48 elastically return, as a result of which the locking projections 86 are disposed so as to oppose the locking edges 52 from above (see FIG. 10). The locking projections 86 are disposed so as to be exposed on the right outer surface and the upper end face of the coupling part 48 through the locking holes 49.

As a result of the locking projections 86 being locked to the locking edges 52, the first attachment member 80A is held so as to be restricted from being separated from the base member 40. In particular, the first attachment member 80A is sandwiched and held between the casing 120 of the battery 100 and the base member 40 in the up-down direction. The projecting piece part 84 is disposed along the bottom surface of the recess 121 of the casing 120. The abutted surface 83 of the attachment rotation suppressing part 81 is disposed so as to contactably face the attachment abutting surface 123 on a side surface of the casing 120 from the right side.

In the case of the second attachment mode, when a force in the rotation direction acts on the battery terminal 20 as a result of fastening to the battery post 110, the abutted surface 45 of the base rotation suppressing part 43 comes into contact with the base abutting surface 122 of the casing 120 from the front, which is the rotation direction, and the abutted surface 83 of the attachment rotation suppressing part 81 comes into contact with the attachment abutting surface 123 of the casing 120 from the right, which is also the rotation direction. Thus, it is possible to prevent the battery terminal 20 from being positionally displaced relative to the battery 100 in the rotation direction. In particular, the respective abutted surfaces 45 and 83 of the base rotation suppressing part 43 and the attachment rotation suppressing part 81 are oriented in directions different from each other, and the abutted surfaces 45 and 83 come into contact with the base abutting surface 122 and the attachment abutting surface 123, respectively, of the casing 120 from directions different from each other. Accordingly, it is possible to increase the reliability in suppressing the rotation and the positional displacement of the battery terminal 20.

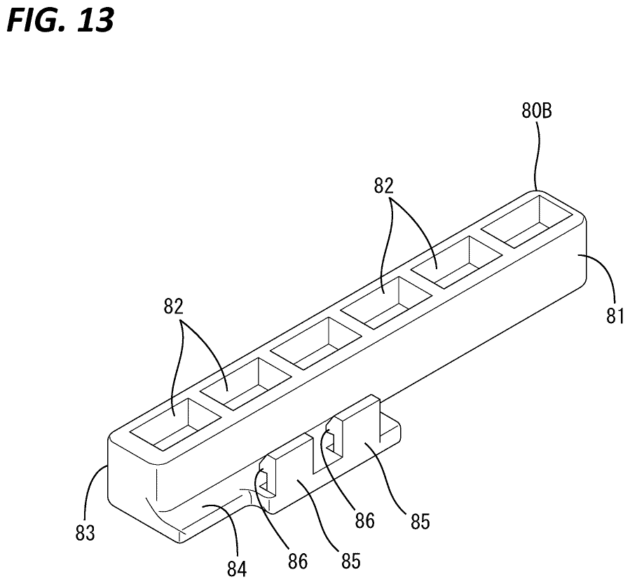

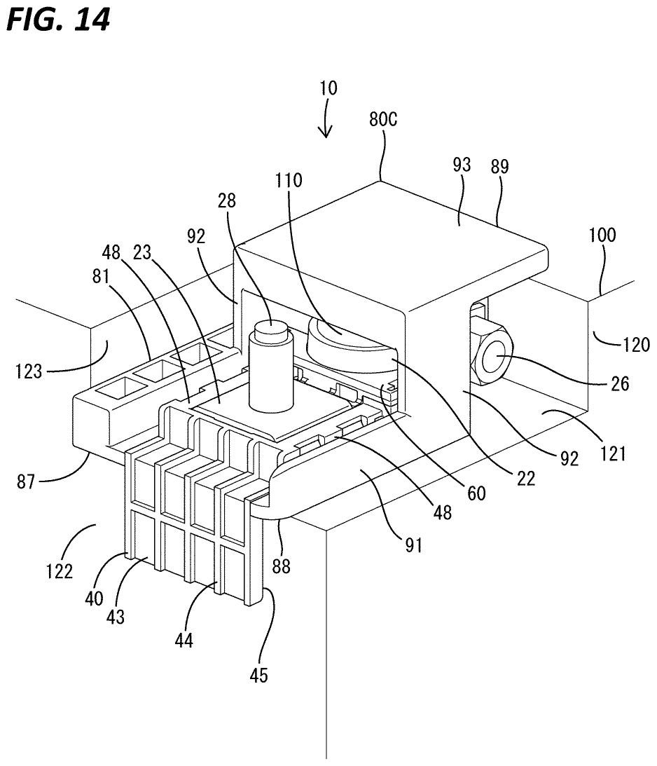

Next, a third attachment mode will be described. As shown in FIG. 12, the third attachment mode is constituted by a battery terminal unit 10 including the battery terminal 20, the base member 40, the interposed member 60, and the second attachment member 80B. As shown in FIG. 13, the second attachment member 80B in the third attachment mode includes a square bar-shaped attachment rotation suppressing part 81 extending in the front-rear direction. The attachment rotation suppressing part 81 has a square or rectangular cross-sectional outer shape as viewed in the front-rear direction. The attachment rotation suppressing part 81 includes a plurality of through holes 82. The through holes 82 extend in the up-down direction, and are open on the upper surface and the lower surface of the attachment rotation suppressing part 81. A plurality of the through holes 82 are arranged side by side in the front-rear direction. The left surface of the attachment rotation suppressing part 81 is configured as an abutted surface 83 that contactably faces the attachment abutting surface 123 of the casing 120 of the battery 100. The abutted surface 83 of the attachment rotation suppressing part 81 is a vertical surface extending along the front-rear direction and the up-down direction.

The second attachment member 80B includes a projecting piece part 84 projecting rightward from the right surface of the attachment rotation suppressing part 81. The projecting piece part 84 has a plate shape that is elongated in the front-rear direction relative to the left-right direction, and is coupled to a front portion and a lower end portion of the right surface of the attachment rotation suppressing part 81. The lower surface of the projecting piece part 84 is continuous with the lower surface of the attachment rotation suppressing part 81 without any difference in height. The front end face of the projecting piece part 84 is continuous with the front surface of the attachment rotation suppressing part 81 without any difference in height. In addition, the second attachment member 80B includes a plurality of locking parts 85 protruding upward from the projecting piece part 84. The locking parts 85 have a plate shape, and are coupled in pairs to the right end of the projecting piece part 84 so as to be spaced apart in the front-rear direction. A pawl-shaped locking projection 86 protrudes leftward from the upper end of each of the locking parts 85.

The second attachment member 80B is attached to the base member 40 from below. The locking parts 85 are inserted into the locking holes 49 of the left coupling part 48 from below. Upon completion of insertion of the locking parts 85, the locking projections 86 are disposed so as to oppose the locking edges 52 from above. As a result of the locking projections 86 being locked to the locking edges 52, the second attachment member 80B is held so as to be restricted from being separated from the base member 40, and is sandwiched and held between the casing 120 of the battery 100 and the base member 40. The projecting piece part 84 and the attachment rotation suppressing part 81 are disposed along the bottom surface of the recess 121 of the casing 120. The abutted surface 83 of the attachment rotation suppressing part 81 is disposed so as to contactably face the attachment abutting surface 123 of the recess 121 of the casing 120 from the right side.

When a force in the rotation direction acts on the battery terminal 20 as a result of fastening to the battery post 110, the abutted surface 45 of the base rotation suppressing part 43 comes into contact with the base abutting surface 122 of the casing 120 from the front, which is the rotation direction, and the abutted surface 83 of the attachment rotation suppressing part 81 comes into contact with the attachment abutting surface 123 of the casing 120 from the right, which is also the rotation direction. Thus, it is possible to prevent the battery terminal 20 from being positionally displaced relative to the battery 100 in the rotation direction. In particular, the respective abutted surfaces 45 and 83 of the base rotation suppressing part 43 and the attachment rotation suppressing part 81 are oriented in directions different from each other, and the abutted surfaces 45 and 83 come into contact with the base abutting surface 122 and the attachment abutting surface 123, respectively, of the casing 120 from directions different from each other. Accordingly, it is possible to increase the reliability in suppressing the rotation of the battery terminal 20. In addition, as shown in FIG. 12, in the case of the third attachment mode, the attachment rotation suppressing part 81 is disposed lateral to the entire battery terminal 20 so as to be in proximity to the battery terminal 20. Accordingly, it is possible to further increase the effect of suppressing the rotation of the battery terminal 20.

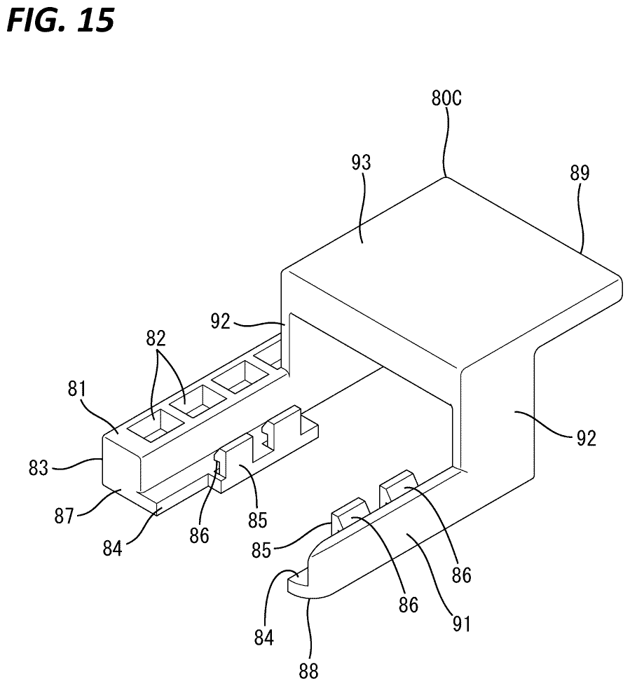

Next, a fourth attachment mode will be described. As shown in FIG. 14, the fourth attachment mode is constituted by a battery terminal unit 10 including the battery terminal 20, the base member 40, the interposed member 60, and the third attachment member 80C. As shown in FIG. 15, the third attachment member 80C in the fourth attachment mode includes a left end portion 87 and a right end portion 88 disposed so as to oppose each other in the left-right direction, and a covering portion 89 disposed between the left end portion 87 and the right end portion 88. The left end portion 87 includes an attachment rotation suppressing part 81, through holes 82, an abutted surface 83, a projecting piece part 84, locking parts 85, and locking projections 86 that have the same shapes as those of the second attachment member 80B in the third attachment mode. The right end portion 88 includes an extension part 91 extending in the front-rear direction. The extension part 91 has a plate shape, and is disposed with a plate surface thereof oriented in the left-right direction. In addition, as in the case of the left end portion 87, the right end portion 88 includes a projecting piece part 84 and a plurality of locking parts 85. A pawl-shaped locking projection 86 protrudes rightward from the upper end of each of the locking parts 85.

The covering portion 89 includes a pair of left and right leg parts 92 protruding upward from the left end portion 87 and the right end portion 88, respectively, and a top wall part 93 spanning between the upper ends of the leg parts 92. Each of the leg parts 92 has a plate shape, and is disposed with a plate surface thereof oriented in the left-right direction. The left leg part 92 is coupled to the laterally inner end of a rear end portion of the attachment rotation suppressing part 81. The right leg part 92 is coupled to a rear end portion of the extension part 91. The right leg part 92 and the extension part 91 are continuous with each other in the up-down direction without any difference in height. The top wall part 93 has a square or rectangular plate shape in plan view. The top wall part 93 and the respective front ends of the leg parts 92 are disposed at the same position in the front-rear direction. The rear end of the top wall part 93 is disposed rearward of the rear ends of the leg parts 92.

The third attachment member 80C is attached to the base member 40. The locking parts 85 of the left end portion 87 are inserted so as to swing into the locking holes 49 of the left coupling part 48 from below. The locking parts 85 of the right end portion 88 are inserted into the locking holes 49 of the right coupling part 48. Here, as a result of the locking projections 86 being locked to the respective corresponding locking edges 52, the third attachment member 80C is held so as to be restricted from being separated from the base member 40. The projecting piece parts 84, the attachment rotation suppressing part 81, and the extension part 91 are disposed along the bottom surface of the recess 121 of the casing 120. The abutted surface 83 of the attachment rotation suppressing part 81 is disposed so as to contactably face the attachment abutting surface 123 of the recess 121 of the casing 120 from the right side. When a force in the rotation direction acts on the battery terminal 20, the abutted surface 45 of the base rotation suppressing part 43 comes into contact with the base abutting surface 122 of the casing 120 from the front, and the abutted surface 83 of the attachment rotation suppressing part 81 comes into contact with the attachment abutting surface 123 of the casing 120 from the right side. Thus, it is possible to prevent the battery terminal 20 from being positionally displaced relative to the battery 100 in the rotation direction. In particular, in the case of the fourth mode, the left and right locking parts 85 are inserted into and locked to the respective corresponding locking holes 49. Accordingly, the third attachment member 80C is stably held by the base member 40. In addition, in the case of the fourth mode, in a state in which the third attachment member 80C is held by the base member 40, the top wall part 93 is disposed so as to cover the battery post 110 from above (see FIG. 14). The post coupling part 22 of the battery terminal 20 is also covered by the top wall part 93. Accordingly, the connection portion between the battery post 110 and the battery terminal 20 is protected from the outside, thus making it possible to prevent short-circuiting, electrical shocks, wetting, and the like.

Finally, a fifth attachment mode will be described. As shown in FIG. 16, the fifth attachment mode is constituted by a battery terminal unit 10 including the battery terminal 20, the base member 40, the interposed member 60, and the fourth attachment member 80D. In the case of the fifth attachment mode, the placement of the recess 121 that accommodates the battery terminal unit 10 is different from those in the first to fourth attachment modes. The recess 121 in the fifth attachment mode has a shape that is cut out over the front surface, the left side surface, and the upper surface at one corner located at the left side and the front side among four upper end corners of the casing 120 of the battery 100. That is, the recess 121 in the fifth attachment mode is disposed at the left end of the casing 120, and differs from the recesses 121 in the first to fourth attachment modes that are disposed at the right end of the casing 120. In the case of the fifth attachment mode, the attachment abutting surface 123 is constituted by the left side surface of the recess 121 of the casing 120. In addition, the battery post 110 is provided upright on the bottom surface of the recess 121 at a position near the right side surface (surface oriented leftward) of the recess 121. In a state in which the battery terminal 20 is installed on the bottom surface of the recess 121, the head portion 27 of the bolt 26 is disposed toward the left, which is the opening direction of the recess 121, relative to the fastening parts 25.

The fourth attachment member 80D in the fifth attachment mode includes a wall-shaped attachment rotation suppressing part 81 extending in the front-rear direction. The right surface of the attachment rotation suppressing part 81 is configured as an abutted surface 83 that contactably faces the attachment abutting surface 123 of the casing 120 of the battery 100. The fourth attachment member 80D includes a projecting piece part 84 projecting rightward from the right surface of the attachment rotation suppressing part 81. The projecting piece part 84 has a quadrangular plate shape in plan view, and is coupled to a front portion and an upper end portion of the right surface of the attachment rotation suppressing part 81. The length of the projecting piece part 84 in the left-right direction is longer than that of the projecting piece part 84 in the second attachment mode. In addition, the fourth attachment member 80D includes a plurality of locking parts 85 protruding upward from the right end of the projecting piece part 84. The locking parts 85 are paired with each other at the right end of the projecting piece part 84 so as to be spaced apart in the front-rear direction, and each include, at the upper end thereof, a pawl-shaped locking projection 86 protruding rightward.

The fourth attachment member 80D is attached to the base member 40 from below. The locking parts 85 are inserted into the locking holes 49 of the left coupling part 48 from below. As a result of the locking projections 86 being locked to the respective corresponding locking edges 52, the fourth attachment member 80D is held so as to be restricted from being separated from the base member 40. The projecting piece part 84 is disposed along the bottom surface of the recess 121 of the casing 120. The abutted surface 83 of the attachment rotation suppressing part 81 is disposed so as to contactably face the attachment abutting surface 123 of the recess 121 of the casing 120 from the left side. When a force in the rotation direction acts on the battery terminal 20, the abutted surface 45 of the base rotation suppressing part 43 comes into contact with the base abutting surface 122 of the casing 120 from the front, and the abutted surface 83 of the attachment rotation suppressing part 81 comes into contact with the attachment abutting surface 123 of the casing 120 from the left side. Thus, the battery terminal 20 is held so as to be prevented from rotating relative to the battery 100.

As described above, the battery terminal unit 10 according to Embodiment 1 includes the battery terminal 20 configured to be connected to the battery post 110 of the battery 100, and the base member 40 configured to be mounted to the battery terminal 20. The base member 40 includes the base rotation suppressing part 43 capable of coming into contact with the base abutting surface 122 of the casing 120 of the battery 100 in the direction in which the battery terminal 20 rotates relative to the battery 100, and the coupling part 48 for attaching the first to fourth attachment members 80A to 80D configured to come into contact with the casing 120.

As a result of the base rotation suppressing part 43 of the battery terminal 20 coming into contact with the base abutting surface 122 of the casing 120 of the battery 100, the battery terminal 20 is suppressed from rotating relative to the battery 100. In the case of changing the mode of attachment of the battery terminal 20 to the battery 100, the first to fourth attachment members 80A to 80D can be attached to the base member 40 via the coupling part 48. This makes it possible to support various attachment modes, thus increasing the versatility of attachment of the battery terminal unit 10.

The battery terminal unit 10 includes the first to fourth attachment members 80A to 80D. The first to fourth attachment members 80A to 80D include the attachment rotation suppressing part 81 capable of coming into contact with the attachment abutting surface 123 of the casing 120 in the direction in which the battery terminal 20 rotates relative to the battery 100. As a result of both the base rotation suppressing part 43 and the attachment rotation suppressing part 81 coming into contact with the casing 120, it is possible to increase the reliability in suppressing the battery terminal 20 from rotating relative to the battery 100.

In addition, in a state in which the first to fourth attachment members 80A to 80D are attached to the base member 40, the respective abutted surfaces 45 and 83 of the attachment rotation suppressing part 81 and the base rotation suppressing part 43 are oriented in directions different from each other. With this configuration, the respective abutted surfaces 45 and 83 of the attachment rotation suppressing part 81 and the base rotation suppressing part 43 can come into contact with the attachment abutting surface 123 and the base abutting surface 122, respectively, from directions different from each other. Thus, it is possible to prevent the battery terminal 20 from being positionally displaced relative to the battery 100 when a force in the rotation direction acts on the battery terminal 20.

In addition, the coupling parts 48 each include the locking holes 49 that are open downward. The first to fourth attachment members 80A to 80D each include the locking parts 85 that are inserted into and locked to the locking holes 49 from below, with distal ends thereof oriented upward. With this configuration, the first to fourth attachment members 80A to 80D are attached to the base member 40 from below. Accordingly, the first to fourth attachment members 80A to 80D are sandwiched and stably held between the base member 40 and the battery 100.

Furthermore, a plurality of the coupling parts 48 are provided at different locations of one base member 40. With this configuration, the first to fourth various attachment members 80A to 80D can be attached to the base member 40 via any given coupling part 48, thus making it possible to further widen the variations of the attachment modes.

### Other Embodiments of the Present Disclosure

It should be appreciated that Embodiment 1 presently disclosed is in all respects illustrative and not limiting.

In the case of Embodiment 1 above, four types of attachment members are provided. In contrast, according to other embodiments, only one type of attachment member may be provided. Alternatively, five or more types of attachment members may be provided.

In the case of Embodiment 1 above, the battery terminal unit includes two coupling parts. In contrast, according to other embodiments, the battery terminal unit may include only one coupling part. Alternatively, the battery terminal unit may include three or more coupling parts. In the case of Embodiment 1 above, the coupling part includes the locking holes, the locking edges, and the outer wall portion. In contrast, according to other embodiments, the coupling part may have any configuration that enables an attachment member to be attached thereto. For example, when the locking parts of the attachment member are elastically deformable, the coupling part may be configured as a fixing part capable of locking to the locking parts. Alternatively, when the locking parts of the attachment member are not elastically deformed, the coupling part may be configured as an elastic locking part capable of elastically locking to the locking parts.

In the case of Embodiment 1 above, the base member is mounted to the battery terminal so as to extend forward of the battery terminal. In contrast, according to other embodiments, the base member may be mounted to the battery terminal so as to extend leftward or rightward of the battery terminal.

In the case of Embodiment 1 above, the battery terminal unit includes the interposed member. In contrast, according to other embodiments, the battery terminal unit need not include the interposed member. In the case of the second to fifth attachment modes according to Embodiment 1 above, one attachment member is attached to the base member. In contrast, according to other embodiments, a plurality of attachment members may be attached to the base member. For example, the first attachment member 80A and the second attachment member 80B may be attached to the base member.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A battery terminal unit comprising:
a battery terminal configured to be connected to a battery post of a battery; and
a base member configured to be mounted to the battery terminal, wherein
the base member includes a base rotation suppressing part capable of coming into contact with a base abutting surface of a casing of the battery in a direction in which the battery terminal rotates relative to the battery about an axis of the battery post, and a coupling part for attaching an attachment member configured to come into contact with the casing.

2. The battery terminal unit according to claim 1,
further comprising the attachment member, wherein
the attachment member includes an attachment rotation suppressing part capable of coming into contact with an attachment abutting surface of the casing in the direction in which the battery terminal rotates relative to the battery.

3. The battery terminal unit according to claim 2, wherein,
in a state in which the attachment member is attached to the base member, respective abutted surfaces of the attachment rotation suppressing part and the base rotation suppressing part are oriented in directions different from each other.

4. The battery terminal unit according to claim 3, wherein
the coupling part includes a locking hole that is open downward, and
the attachment member includes a locking part configured to be inserted into and locked to the locking hole from below, with a distal end thereof oriented upward.

5. The battery terminal unit according to claim 1, wherein
a plurality of the coupling parts are provided at different locations of the base member.
